(19) United States
(12) Patent Application Publication
(10) Pub. No.: US 2009/0204585 A1
(43) Pub. Date: Aug. 13, 2009

(54) DOCUMENT MANAGEMENT SYSTEM, DOCUMENT MANAGEMENT APPARATUS, DOCUMENT MANAGEMENT METHOD AND PROGRAM

(75) Inventor: Nobuyuki Shigeeda, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/364,653

(22) Filed: Feb. 3, 2009

(30) Foreign Application Priority Data
Feb. 7, 2008 (JP) 2008-028121

(51) Int. Cl. G06F 17/30

(52) U.S. Cl. 707/3; 707/E17.014

(57) ABSTRACT

A document management system includes a registration unit that, for each of a plurality of document data pieces, registers information in a partial area constituting the document data piece and comment information added to describe content of the partial area information, in a storage unit in association with each other, a search unit that searches the storage unit to find partial area information that corresponds to information in a partial area designated in a document data piece being browsed by a user, and a search result display unit that displays, on a display unit, comment information added to the partial area information that was found.

### BACKGROUND OF THE INVENTION

1. Field of the Invention

The present invention relates to document management technology for managing document data.

2. Description of the Related Art

Document management systems include a comment function for adding comments to document data. The comment function can assign comment information to each piece of image data and character string information included in the document data, and stores the comment information in association with the document data and image data. The comment function can also assign comment information to character string information and the like in the document data, and store the comment information as part of the data constituting the document data. Furthermore, the comment function can associate the comment information with the document data, and store the comment information separately from the document data.

Japanese Patent Laid-Open No. 2005-228262 discloses technology in which an annotation attached to digital data is managed separately from the digital data. A user of the digital data can be notified of the annotation as a message by a communication function. Applying this conventional technology enables comment information and the like assigned to document data to be referenced as reference information by a plurality of people. For example, comment information that descriptively describes the content of document data, such as “This document data is the minutes of the ‘XYZ conference’”, can be referenced by a plurality of users as reference information assigned to the document data.

Also, there is a “knowledge information usage” use case in which information accumulated for a plurality of pieces of document data by a memo function is reused when newly editing a piece of document data. In this use case, comment information and the like that was previously assigned to various pieces of document data can be reused as knowledge information.

In conventional technology such as Japanese Patent Laid-Open No. 2005-228262, comment information and the like assigned to a specific piece of document data can be shared among a plurality of users. However, comment information and the like assigned to other pieces of document data cannot be used efficiently, which is a problem. For example, cross-referencing the comment information assigned to a plurality of pieces of document data requires the pieces of document data to be opened one-by-one. Alternatively, the operation of searching the comment information stored in association with the pieces of document data would be required. In the former example, in order to find the effective piece of comment that the user is looking for, the user must perform the inefficient task of opening an enormous amount of document data pieces one-by-one. Accordingly, the user cannot perform a search efficiently. In the latter example, the effective information would be buried among comment information and the like not intended by the user, thus making it impossible to efficiently search for the comment information required by the user.

### SUMMARY OF THE INVENTION

In view of the above-described problems in conventional technology, an object of the present invention is to provide document management technology that enables a user to efficiently provide and search for required comment information when, for example, browsing document data.

According to one aspect of the present invention, there is provided a document management system comprising: a registration unit adapted to, for each of a plurality of document data pieces, register (i) information in a partial area constituting the document data piece and (ii) comment information added to describe content of the partial area information, in a storage unit in association with each other; a search unit adapted to search the storage unit to find partial area information that corresponds to information in a partial area designated in a document data piece being browsed by a user; and a search result display unit adapted to display, on a display unit, comment information added to the partial area information found by the search unit.

According to another aspect of the present invention, there is provided a document management method in a document management system, the method comprising the steps of: for each of a plurality of document data pieces, registering (i) information in a partial area constituting the document data piece and (ii) comment information added to describe content of the partial area information, in a storage unit in association with each other; searching the storage unit to find partial area information that corresponds to information in a partial area designated in a document data piece being browsed by a user; and displaying, on a display unit, comment information added to the partial area information found in the searching step.

According to still another aspect of the present invention, there is provided a document management apparatus comprising: a registration unit adapted to, for each of a plurality of document data pieces, register (i) information in a partial area constituting the document data piece and (ii) comment information added to describe content of the partial area information, in a storage unit in association with each other; a search unit adapted to search the storage unit to find partial area information that corresponds to information in a partial area designated in a document data piece being browsed by a user; and a search result output unit adapted to output comment information added to the partial area information found by the search unit.

According to yet another aspect of the present invention, there is provided a document management method in a document management apparatus, the method comprising the steps of: for each of a plurality of document data pieces, registering (i) information in a partial area constituting the document data piece and (ii) comment information added to describe content of the partial area information, in a storage unit in association with each other; searching the storage unit to find partial area information that corresponds to information in a partial area designated in a document data piece being browsed by a user; and outputting comment information added to the partial area information found in the searching step.

According to still yet another aspect of the present invention, there is provided a program that is stored on a computer-readable storage medium and causes a computer to execute a document management method in a document management apparatus, the method comprising the steps of: for each of a plurality of document data pieces, registering (i) information in a partial area constituting the document data piece and (ii) comment information added to describe content of the partial area information, in a storage unit in association with each other; searching the storage unit to find partial area information that corresponds to information in a partial area designated in a document data piece being browsed by a user; and outputting comment information added to the partial area information found in the searching step.

The present invention enables a user to efficiently provide and search for required comment information when, for example, browsing document data.

Further features of the present invention will become apparent from the following description of exemplary embodiments (with reference to the attached drawings).

### BRIEF DESCRIPTION OF THE DRAWINGS

FIG. 1 schematically shows a system of a document management system according to an embodiment of the present invention.

FIG. 2 shows a hardware structure of PCs constituting the document management system according to the embodiment of the present invention.

FIG. 3 shows an exemplary software structure of the document management system according to the embodiment of the present invention.

FIG. 4 shows a structure of database tables in a base comment repository.

FIG. 5 illustrates the generation of a temporary comment repository.

FIG. 6 illustrates the generation of a knowledge message list according to content designated by a user from the temporary comment repository.

FIG. 7 shows an exemplary operation screen on which a user generates and edits document data in the document management system according to the embodiment of the present invention.

FIG. 8 is a flowchart illustrating a flow of processing for updating document data and updating the base commentary repository.

FIG. 9 is a flowchart illustrating a flow of processing for updating the temporary comment repository.

FIG. 10 is a flowchart illustrating a flow of processing for controlling display of a knowledge message list 205.

### DESCRIPTION OF THE EMBODIMENTS

Below is a detailed description of an exemplary preferred embodiment of the present invention with reference to the drawings. Note that the constituent elements described in the embodiment are merely examples. The technical scope of the present invention is to be determined according to the scope of the claims, and is of course not limited to the following individual embodiment.

System Structure

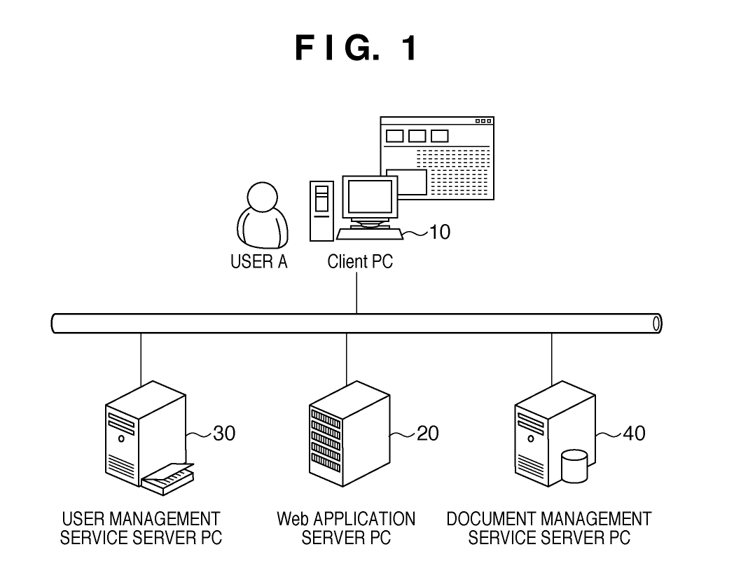

FIG. 1 schematically shows a system of a document management system according to the embodiment of the present invention. In the present invention, for example, a document management application for providing a user A with the functionality of a document management system is provided as a web service (a web application). The user A uses a client PC 10 to access the document management system via a browser. A web application server PC 20 provides the web application of the document management system. A user management service server PC 30 that manages information pertaining to the user A who is accessing the document management system is connected via a network to a document management service server PC 40 that stores and manages document data.

Although the web application server PC 20, user management service server PC 30, and document management service server PC 40 are disposed separately in this description, these constituent elements may be constituted in one PC. Also, although the user A operates the client PC 10 in the above description, the user A may operate a PC that is the same as any or all of the three server PCs.

Furthermore, although the user A accesses the document management system of the present embodiment via a browser in this description, a dedicated client application not shown in FIG. 1 may be provided in the client PC 10, and the user A may operate the dedicated client application. In this case, the document management service server PC 40 may communicate with the dedicated client application instead of with the web application server PC 20.

Hardware Structure

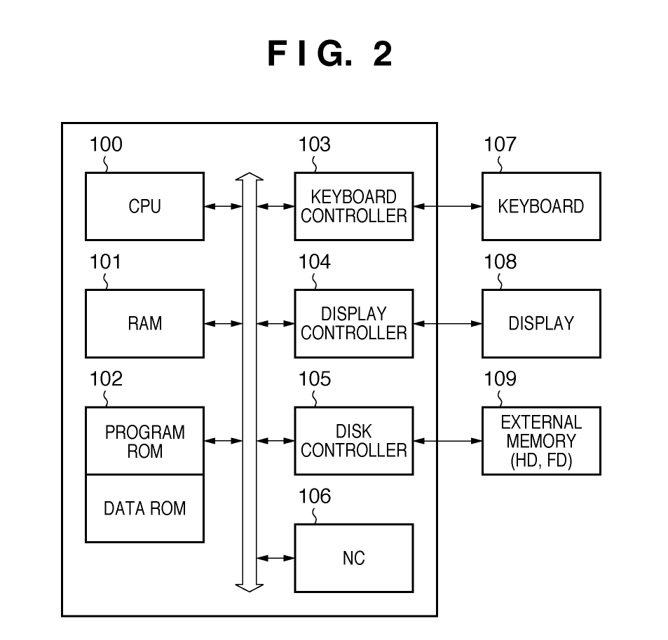

FIG. 2 shows a hardware structure of the PCs constituting the document management system according to the embodiment of the present invention. Note that the hardware structure diagram of FIG. 2 corresponds to a hardware structure diagram of a general information processing apparatus, and the hardware structure of a general information processing apparatus is applicable to the PCs of the present embodiment.

A CPU 100 executes programs such as an OS and applications that are stored in a program ROM of a ROM 102, or that have been loaded to a RAM 101 from an external memory 109 such as a hard disk (HD). Here, “OS” is an abbreviation for an operating system that runs on a computer, and hereinafter the operating system is called an OS. The processing shown in later-described flowcharts can be realized by the execution of the above programs. The RAM 101 functions as a main memory, work area, or the like of the CPU 100. A keyboard controller 103 controls key input from a keyboard 107 and a pointing device that is not shown in FIG. 2. A display controller 104 controls various displays performed by a display 108. A disk controller 105 controls data accesses to the external memory 109 that stores various types of data. Examples of the external memory 109 include a hard disk (HD) and a flexible disk (FD). An NC 106 is connected to the network and performs processing for controlling communication with other devices connected to the network.

Software Structure

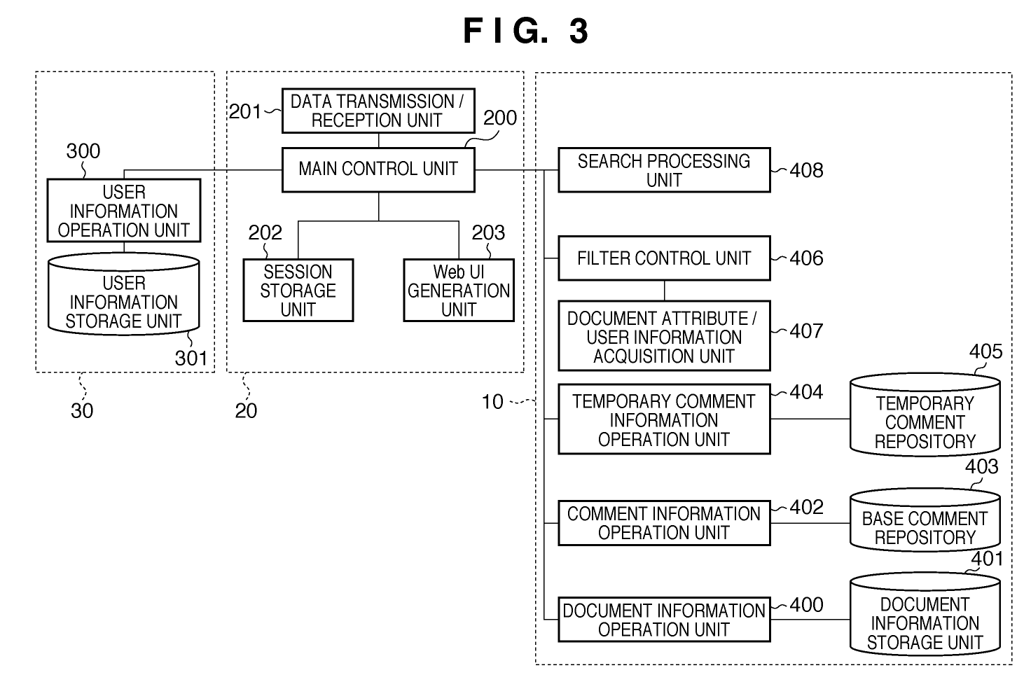

FIG. 3 shows an exemplary software structure of the document management system according to the embodiment of the present invention. Specifically, FIG. 3 shows exemplary software structures of the web application server PC 20, user management service server PC 30, and document management service server PC 40. A main control unit 200 performs overall control of the document management system according to the embodiment of the present invention, and manages and sends instructions to later-described units.

A data transmission/reception unit 201 receives an instruction issued by the user via the browser of the client PC 10, and transmits a result instructed by the main control unit 200 to the client PC 10.

A session storage unit 202 generates session information for indicating that access is being performed by the same user as the user who has been accessing (is logged in to) the document management system via the browser of the client PC 10. Furthermore, the session storage unit 202 stores various types of information, such as history information indicating a history of repeated use by the user, in association with the session information until the session is ended by, for example, the user ending the access to (logging out of) the document management system, or an automatic time-out.

A WebUI generation unit 203 receives an instruction from the main control unit 200 and generates a context-sensitive WebUI (HTML). Here, the WebUI generated by the WebUI generation unit 203 is not limited to only HTML. A scripting language such as JavaScript may be embedded in the WebUI.

In accordance with an instruction from the main control unit 200, a user information operation unit 300 performs operations such as the extraction and editing of user information and a list of users who can access the document management system, which are stored in a user information storage unit 301. Here, instead of user management being performed solely by the document management system, the user information operation unit 300 may operate in cooperation with an Active Directory, LDAP, or the like, which are existing technologies, and the user information storage unit 301 may store only the user information.

In accordance with an instruction from the main control unit 200, a document information operation unit 400 performs operations such as the registration, storage, extraction, and editing of actual document data and document attributes that are stored in a document information storage unit 401.

In accordance with an instruction from the main control unit 200, a comment information operation unit 402 performs various types of operations and information processing for storing, reading, and updating comment information. Here, comment information is additional information composed of an arbitrary character string that has been added to describe the content of information (e.g., text data or image data) in a partial area constituting document data. For example, a supplementary description of partial area information (e.g., text data or image data) designated in the document data can be shared between a plurality of users by the users referencing the comment information. Comment information can be assigned by the creator of document data, and can also be added by a third party who is referencing document data. Comment information can be assigned after document data has been registered in the document information storage unit 401 of the document management service server PC 40.

Based on an instruction from the main control unit 200, the comment information operation unit 402 stores comment information in a base comment repository 403 that functions as a storage unit. The base comment repository 403 receives an instruction from the comment information operation unit 402 and stores the comment information in association with document attributes, user information, and the like. Note that the data table structure of the base comment repository 403 is described later.

A temporary comment information operation unit 404 performs operations and information processing for reading and writing data from/to a temporary comment repository 405, updating such data, and the like. The temporary comment repository 405 temporarily holds predetermined comment information that has been selected from the base comment repository 403 in a later-described method. The temporary comment information operation unit 404 performs the operations and information processing (reading, writing, updating, etc.) with respect to the temporary comment repository 405 under control of the main control unit 200.

In the generation of the temporary comment repository 405, a filter control unit 406 filters the comment information held in the base comment repository 403, using an attribute of document data being browsed or edited by a user and a user characteristic as keys.

A document attribute/user information acquisition unit 407 acquires document attributes and user information. Here, a document attribute is information pertaining to document data, such as a category appropriate to the content of the document data being created by a user, a creation date or creator of the document data, a user of the document data, an application used to create the document data, and a creation location. The document attribute may be set explicitly by the document creator while creating a document, may be set automatically by the application that is creating the document, may be designated by another user who is referencing the document, or the like.

User information is information pertaining to users, such as the name of a user who is browsing or editing document data, the user's affiliation name, organization code, affiliated project, position (job title), contact information, address information, or the like. User information may be set explicitly by the user himself/herself, may be set by the user's manager, may be set automatically by software or an OS on a PC that the user is using, or the like. Also, user information is set and identified in the document management system when a user logs in to the document management system.

Comment information to be added to existing document data is associated with an attribute of the existing document or a characteristic of the user who is adding a comment. When newly editing document data, information (knowledge information) included in comment information can be efficiently searched for and reused by referencing comment information associated with the same document attribute or user information.

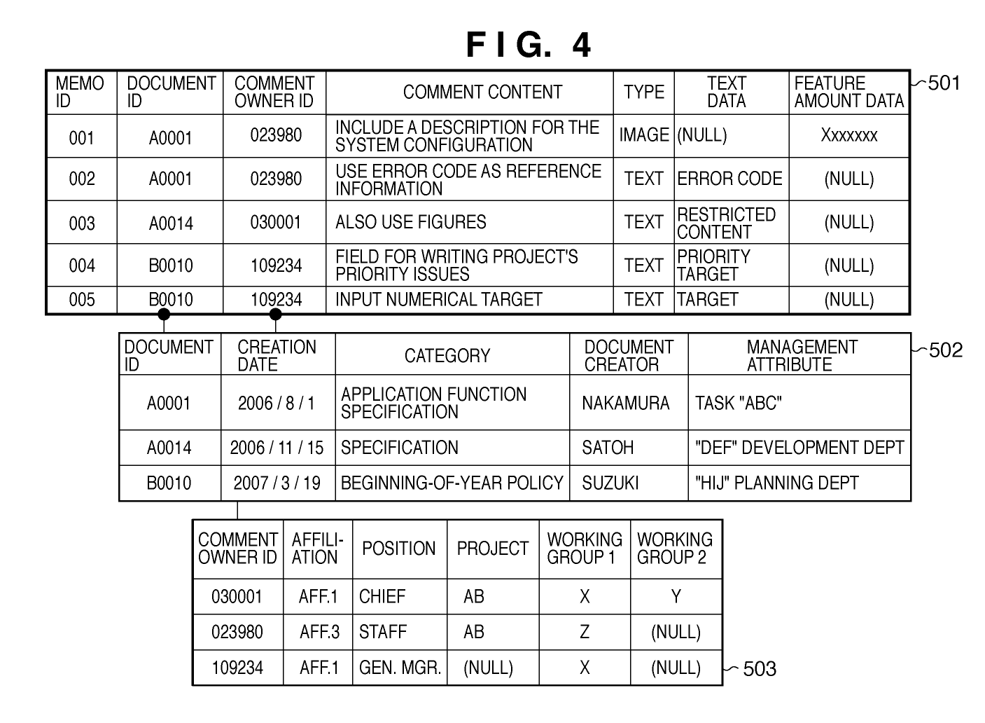

Note that information indicating document attributes and user information is registered in a document attribute table and a user information table respectively, which are shown in FIG. 4 and described later. These tables constitute the base comment repository 403.

In accordance with an instruction from the main control unit 200, a search processing unit 408 acquires a search result from the document information storage unit 401 via the document information operation unit 400. The search processing unit 408 also designates a document attribute and user information, and acquires and holds a search result from the temporary comment repository 405 via the temporary comment information operation unit 404.

Note that in accordance with an instruction from the filter control unit 406, the search processing unit 408 is also used when acquiring a comment information filtering result from the base comment repository 403 via the comment information operation unit 402.

Base Comment Repository Structure

FIG. 4 illustrates the structure of database tables constituting the base comment repository 403. The base comment repository 403 includes a comment management table 501, a document attribute table 502, and a user information table 503.

The document attribute table 502 stores document attributes for specifying, from among a plurality of document data pieces, document data pieces to which comment information has been added. The document attributes are information such as a document data category, a department that is managing document data, a document creator, or the like. The user information table 503 stores user information for specifying users who have added comment information to document data. The user information is information such as the name of the project to which a user belongs, a user's working group, a user's job title, or the like.

The comment management table 501 includes added comment information, text data, feature amount data (image feature amounts) calculated based on image data, and identification information (document IDs) for identifying document data to which comment information has been added.

An image feature amount is data that indicates a quantitative feature amount that indicates a characteristic of image data to which comment information has been added. Examples of such data include edge information, luminance information, and color information of image data. In the present embodiment, an existing algorithm such as a similarity operation is used when searching for and extracting an image feature amount. Searching is performed to find document data having feature amount data (an image feature amount) whose similarity is greater than or equal to a similarity that has been predefined by a result of the similarity operation.

Text data to which comment information has been added and feature amount data (image feature amount) that has been calculated (extracted) based on image data to which comment information has been attached are used as comparison information and set as comparison targets when performing a comparison with other comment information.

A document ID is identification information for uniquely specifying document data managed by the document management service server PC 40. A comment owner ID is identification information for identifying a user who has added comment information to document data.

The base comment repository 403 includes the document attribute table 502 in which document IDs are the main key and the user information table 503 in which comment owner IDs are the main key. The tables 502 and 503 are related to the comment management table 501.

The document attribute table 502 includes document IDs as the main key, creation dates, categories, creators, management attributes, or the like for document data indicated by the document IDs. The user information table 503 includes comment owner IDs as the main key, and user attributes such as an affiliation, position, affiliated project, affiliated working group, or the like for each comment information creator.

Temporary Comment Repository Generation

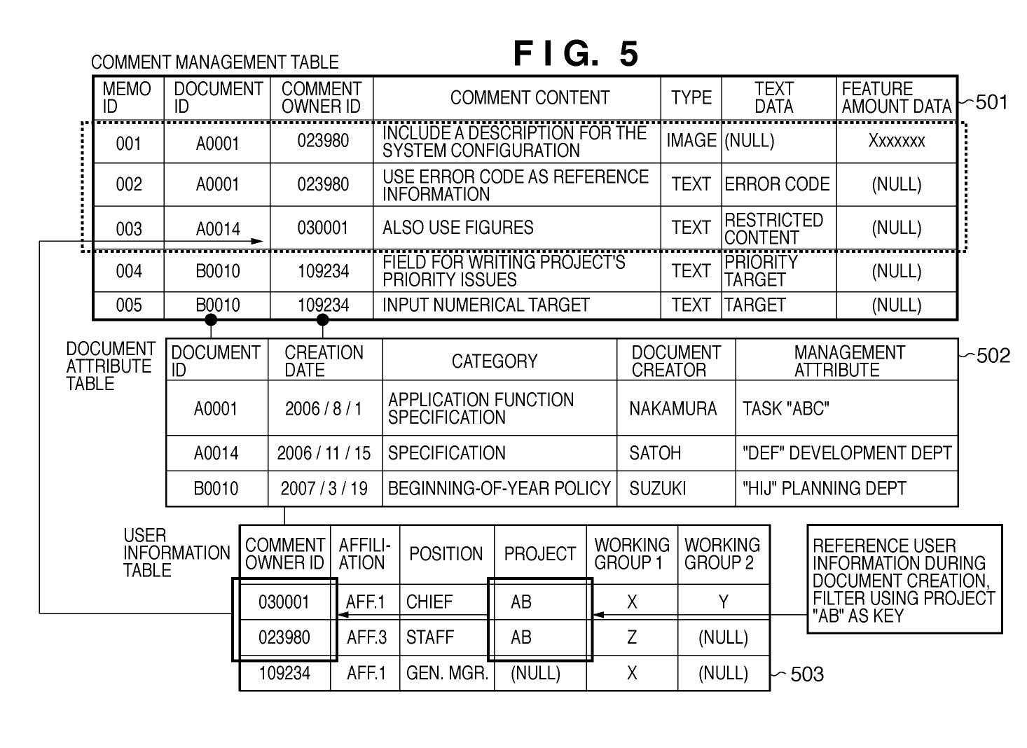

FIG. 5 illustrates the generation of the temporary comment repository 405 in the document management service server PC 40.

The temporary comment repository 405 is a comment information storage table that has been newly created by temporarily narrowing down information in the comment information (comment content) stored in the base comment repository 403. The following describes the generation of the temporary comment repository 405, following the arrows shown in FIG. 5.

In the present embodiment, the user information table 503 in the base comment repository is referenced using a user information piece as the key. Here, the user information piece used as the key is the project with which the user editing document data is affiliated, and “AB” is the project with which the user is affiliated. In this case, items whose value in the project column of the user information table 503 is “AB” are selected. Next, the comment management table 501 is referenced using the comment owner IDs associated with project “AB” as the keys. Here, the two comment owner IDs “030001” and “023980” are associated with project “AB”.

Next, the comment management table 501 is referenced using the comment owner IDs “030001” and “023980” as the keys, and the memo IDs associated with these comment owner IDs are selected. Here, the three memo ID items “001”, “002”, and “003” are associated with the above comment owner IDs. As a result, the temporary comment repository 405 stores information corresponding to the memo IDs “001”, “002”, and “003”.

The temporary comment repository 405 is generated or updated when the user logs in to the document management system, when the user newly creates or edits document data, or when a document attribute or user information has been updated. Accordingly, when the user is creating a document or updates an attribute, the result thereof is immediately reflected in the temporary comment repository 405. Comment content is held in correspondence with each memo ID, and the temporary comment repository 405 includes the result of filtering processing performed using the document attribute and user information as keys. For this reason, comment content associated with the attribute of the document the user is attempting to create and the user characteristic is selected and held in the temporary comment repository 405.

The generation of the temporary comment repository 405 is performed via the filter control unit 406 based on an instruction from the main control unit 200 shown in FIG. 3. In the acquisition of the document attribute and user information, the filter control unit 406 instructs the document attribute/user information acquisition unit 407 to acquire such information. Note that a detailed processing flow for generating the temporary comment repository 405 is described later.

The temporary comment repository 405 is held and updated at appropriate times while the user is logged in to the document management service server PC 40. When the user has logged out of the document management service server PC 40, the temporary comment repository 405 is discarded, and the storage area is released.

Knowledge Message List Generation

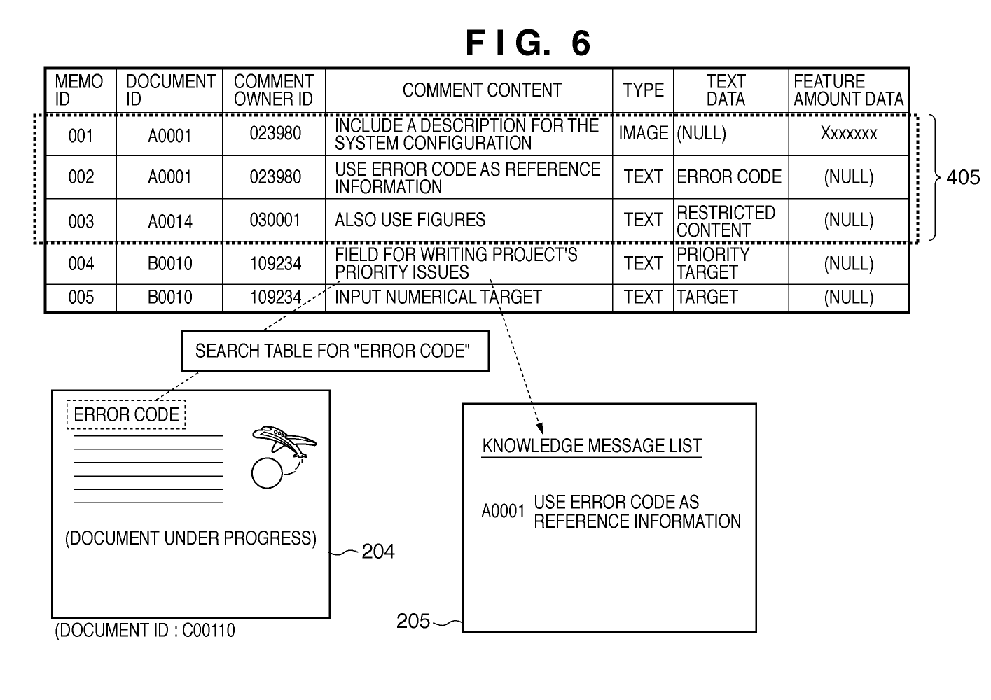

FIG. 6 illustrates the generation of a knowledge message list from the temporary comment repository 405 in accordance with content designated by the user. In FIG. 6, document data 204 is document data that is currently being edited (created) and displayed in the web browser of the client PC 10. The unique identification information “C00110” has been assigned to the document data 204 as a document ID for identification thereof, and the document data 204 is stored in the document information storage unit 401. The under-progress document data 204 is managed in the web application, and is generated by the WebUI generation unit 203 in accordance with an instruction received from the main control unit 200.

The user can use the web browser to edit the under-progress document data 204 in the client PC 10. The user can input characters or the like into fields in the under-progress document data 204 being displayed in the web browser. The main control unit 200 receives a data input from the user, sends an instruction to the document information operation unit 400, and stores data regarding the content of the document data 204 in the document information storage unit 401.

The arrows in FIG. 6 express the concept in which the temporary comment information operation unit 404 acquires information to be a key from a field designated by the user, searches the temporary comment repository 405, and generates the knowledge message list 205.

When the user designates a text area in the document data on the browsing screen while browsing or editing the document data, the main control unit 200 identifies text data in the designated text area. The main control unit 200 transmits the identified text data to the search processing unit 408. The search processing unit 408 receives the text data transmitted by the main control unit 200, and using the received text data as a query, searches the comment content and text data to which comments have been attached that are stored in the temporary comment repository 405.

The search processing unit 408 transmits a result of the search to the main control unit 200, and the main control unit 200 transmits the received search result to the WebUI generation unit 203. The WebUI generation unit 203 generates HTML based on the search result transmitted from the main control unit 200. In accordance with an instruction from the main control unit 200, the HTML generated by the WebUI generation unit 203 is transmitted to the web browser of the client PC 10 via the data transmission/reception unit 201. The generated HTML is displayed in the web browser as the knowledge message list 205.

Here, the knowledge message list 205 is a list indicating past comment information that is associated with the text area in the under-progress document data 204 that was designated by the user. In the base comment repository 403, memo IDs are the main keys, and comment information for a plurality of document data pieces is associated with the memo IDs by a plurality of document IDs. For this reason, the comment information displayed in the knowledge message list 205 includes not only comment information added to the document data being edited by the user, but also comment information that has been added to other document data. This enables the user to selectively reference comment information that is strongly correlated in terms of user information and a document attribute, while editing the document data.

The knowledge message list 205 is a list displayed on the display 108 that includes, for example, a combination of the content of comment information and the document ID of the document to which the comment information was added, as shown in FIG. 6. If a plurality of comment information pieces are found, a plurality of combinations of comment information and a document ID are displayed as a list in the knowledge message list 205.

Each document ID in the knowledge message list 205 is linked so as to enable accessing the corresponding document data. By using an input apparatus such as a mouse to select and click a document ID, the user can cause the display 108 to display other document data to which comment information has been added, in combination with the editing screen. This enables the user to check, based on the on-screen display, what kind of comments have been added to what kind of document data.

In the case of FIG. 6, the user has designated the recitation range “error code” in the under-progress document data 204. The main control unit 200 identifies the designated range “error code”, and transmits the identified text data “error code” to the search processing unit 408.

The search processing unit 408 searches for any messages including “error code” in the temporary comment repository 405 generated based the project “AB”. In the case of FIG. 6, memo ID “002” and document ID “A0001” are found as document data including the text data “error code”, and the comment content “Use the error code as reference information” is read as a search result. This search result is displayed in the knowledge message list 205 as the previously recorded comment information “A0001 Use the error code as reference information”.

Meanwhile, if the base comment repository 403 were directly searched based on the keyword “error code”, comments related to other projects that have no relation to the project “AB” would be also be targets of the search. As a result, the knowledge message list 205 would include a large amount of comment information added to documents that are related to other projects, which the document creator did not intend to be displayed. Such comment information is information that the document created did not intend to be displayed, and is noise in the search processing. In the present embodiment, the target of the search is the temporary comment repository 405 that has been generated by performing filtering to narrow the related search range based on the user information of the document creator. This eliminates information that would be noise when performing search processing, thus enabling an increase in precision of the comment information to be filtered.

Although FIG. 6 illustrates an exemplary case in which a text area is designated as a designated range, the scope of the present invention is not limited to this example. The user can also designate an image area in the under-progress document data 204. Instead of merely text data in a document, comment information can be assigned to image data as well. In this case, the content of the comment is stored in the base commentary repository 403 in association with an image feature amount that characterizes an image.

If the user designates an image area in the under-progress document data 204, the search processing unit 408 extracts an image feature amount of the corresponding designated area in accordance with an instruction from the main control unit 200. The search processing unit 408 then compares the extracted image feature amount with image feature amounts stored in the temporary comment repository 405 that was generated by performing filtering based on the user information of the document creator. The search processing unit 408 performs a similarity judgment based on a result of the comparison, and displays comment information having a high similarity in the knowledge message list 205. Subsequent processing is similar to the case of designating a text area. If comment information is targeted, the search processing unit 408 determines a priority order in order of highest similarity, and the comment information is listed in the knowledge message list 205 in accordance with the priority order.

User Screen

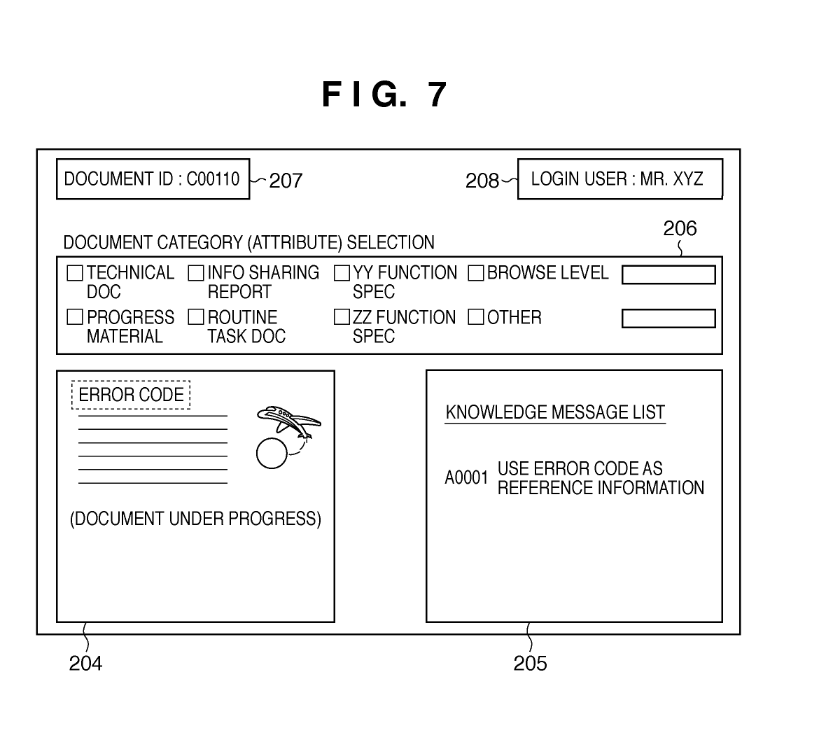

FIG. 7 shows an exemplary operation screen on which a user generates and edits document data in the document management system according to the embodiment of the present invention. The user can use the web browser of the client PC 10 to access the web application server PC 20. In FIG. 7, the under-progress document data 204 and knowledge message list 205 are displayed in a web browser screen.

In FIG. 7, document attributes are explicitly designated based on input to checkboxes 206 that function as a document category (attribute) selection field. By turning a checkbox 206 ON (inputting a check), the user can designate attributes of the document data being edited as necessary. A document ID 207 indicates the document ID of the document being edited. The document ID is identification information that identifies the document data currently being edited by the user. Note that other document data can be edited by designating a document name to open the other document data, and therefore it goes without saying that a menu (not shown) for this purpose is provided.

An input field 208 in FIG. 7 is a field for identifying a login user. The input field 208 can identify the user that is logged in to the document management service server PC 40. Note that management of the login session is performed by the session storage unit 202 in accordance with an instruction from the main control unit 200. Also, processing regarding the login session and user authentication processing, such as logging in and logging out, is performed by the user information operation unit 300. User information, including authentication information, is stored in the user information storage unit 301 shown in FIG. 3.

Document Data Updating and Base Comment Repository Updating

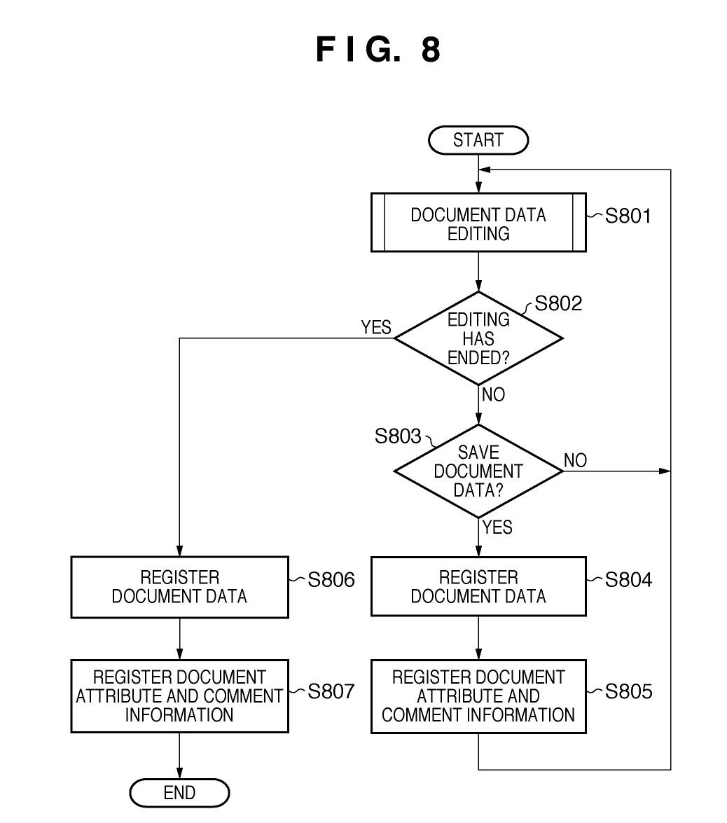

FIG. 8 is a flowchart illustrating a flow of processing for updating document data and updating the base commentary repository 403. The processing for updating document data and updating the base commentary repository 403 is executed as part of the processing performed by the main control unit 200 described using FIG. 3.

The processing in the flowchart of FIG. 8 is started when the user edits document data. Step S801 is a step in which the document data is edited. The assignment of comment information to the document data is also performed in step S801. The assigned comment information, user information for specifying the user who assigned the comment information, a document attribute for specifying the document data to which the comment information was added, and the updated document data are all data-cached.

In step S802, a judgment is made as to whether to end the document data editing operation. In a case of ending the editing operation, processing proceeds to step S806. In a case of not ending the document data editing operation, processing proceeds to step S803. In step S803, a judgment is made as to whether to save the document data. In a case of not saving the document data, processing returns to step S801, and the document data editing processing is continued (step S801). In a case of judging to save the document data in step S803, processing proceeds to step S804 in which the main control unit 200 transmits the data-cached document data to the document information operation unit 400, and the document information operation unit 400 stores and registers the received document data in the document information storage unit 401.

In step S805, the main control unit 200 transmits the user information, the document attributes, and the data-cached comment information to the comment information operation unit 402. The comment information operation unit 402 registers the received user information and document attributes, and updates the base comment repository 403.

Thereafter, processing again returns to the document editing step S801.

In a case of judging to end the editing operation in step S802, processing proceeds to step S806 in which the main control unit 200 transmits the data-cached document data to the document information operation unit 400, and the document information operation unit 400 stores and registers the received document data in the document information storage unit 401. The processing for storing and registering the document data in step S806 is the same as the processing in step S804.

In step S807, the user information, document attributes, and data-cached comment information are stored and registered in the base comment repository 403. Processing for storing and registering the document attributes and comment information in step S807 is the same as the processing in step S805. As a result of the above processing, a series of data-cache storage processing is performed, after which processing ends.

Processing for updating the base comment repository 403 is performed in steps S805 and S807, and in the present embodiment, the trigger for this processing is a user operation such as saving the document being edited or ending the editing operation. However, the application may be designed so that steps S804 and S805 are automatically performed at a constant time interval, thereby enabling document data storage and registration and updating of the base comment repository 403 to be performed automatically and separately from the user operation.

Temporary Comment Repository Updating

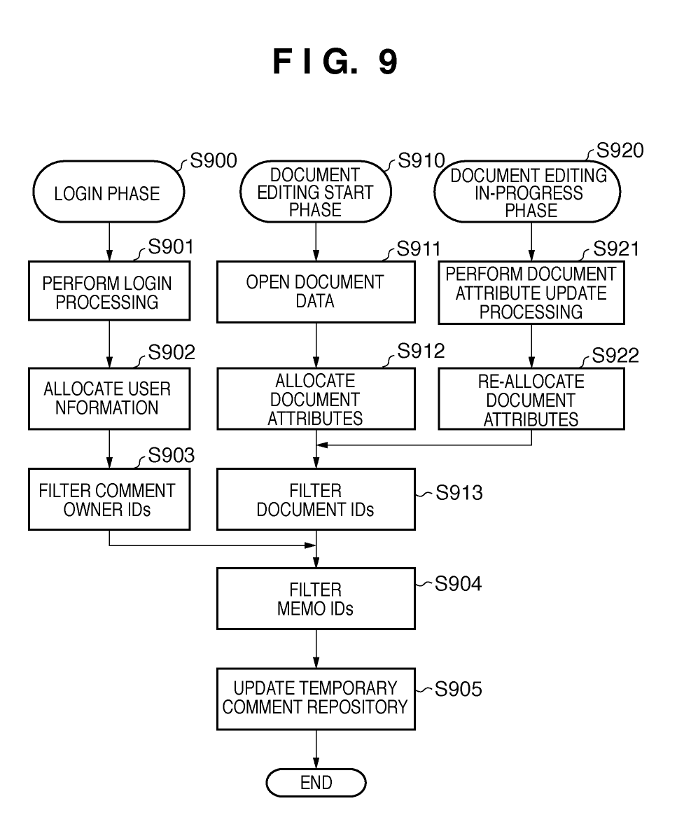

FIG. 9 is a flowchart illustrating a flow of processing for updating the temporary comment repository 405.

The processing for updating the temporary commentary repository 405 is executed as part of the processing performed by the main control unit 200 described using FIG. 3. Also, the processing for updating the temporary comment repository 405 includes three processing phases, namely a login phase S900, a document editing start phase S910, and a document editing in-progress phase S920.

The login phase S900 is a processing phase performed in a case of the user logging in to the document management service server PC 40. The user designates a user ID and password to start the login processing for logging in to the document management service server PC 40.

In step S901, login processing is performed. In the login processing step, user authentication processing is performed based on the user ID and password information. The authentication processing is performed in the user management service server PC 30.

If the user authentication is successful, processing proceeds to step S902 in which processing for allocating the user information is performed. Since the user is identified by the user authentication, the user information stored in the user information storage unit 301 is allocated to a predetermined memory area managed by the main control unit 200. Note that if the user authentication fails, the login processing of step S901 is performed again (not shown).

In step S903, comment owner ID filtering processing is performed. The information stored in the user information table 503 shown in FIG. 4 is searched based on information included in the allocated user information. Since the user information table 503 stores various types of information, the user can designate user-specific setting information in the application in advance to indicate the information of which user information is to be used. For example, the processing of step S903 corresponds to the filtering processing shown in FIG. 5 in which the user information is narrowed down to the comment owner IDs “030001, 023980”, using the project name “AB” to which the user belongs as the key.

In step S904, memo ID filtering processing is performed. Processing for filtering the memo IDs in the comment management table 501 is performed using the comment owner IDs obtained by the filtering processing of step S903 as keys. For example, the processing of step S904 corresponds to the filtering processing shown in FIG. 5 in which the memo IDs are narrowed down to the memo IDs “001, 002, 003”, using the comment owner IDs “030001, 023980” as keys.

In step S905, temporary comment repository update processing is performed. The content of the temporary comment repository 405 is updated based on the memo IDs obtained by the filtering processing of step S904.

The above processing completes the processing for updating the temporary comment repository 405 in the login phase.

The following describes a flow of processing for updating the temporary comment repository 405 in the document editing start phase (step S910).

The document editing start phase S910 is a processing phase performed when the user, after logging in, designates predetermined document data to start editing.

In step S911, document data opening processing is performed. The document data opening processing is processing in which the user designates and opens document data in order to edit the document data. It is at this timing that an attribute assigned to the document data is first identified.

In step S912, document attribute allocation processing is performed. The attribute (document attribute) that is assigned to the document data and was identified in the processing of step S911 is allocated to a predetermined memory area managed by the main control unit 200.

In step S913, document ID filtering processing is performed. The document attribute table 502 that constitutes the base comment repository 403 is searched using the document attribute allocated in the processing of step S912 as the key, thus filtering the document IDs to document IDs that correspond to the allocated document attribute.

In step S904, memo ID filtering processing is performed. The memo IDs are filtered by searching the comment management table 501 using the document IDs as keys. Although the memo IDs are filtered using the comment owner IDs as keys in the login phase S900, the memo IDs are filtered using the document IDs as keys in the document editing start phase S910.

In step S905, temporary comment repository update processing is performed. The content of the temporary comment repository 405 is updated based on the memo IDs obtained by the filtering processing of step S904.

The above processing completes the processing for updating the temporary comment repository 405 in the document editing start phase.

The following describes a flow of processing for updating the temporary comment repository 405 in the document editing in-progress phase (step S920).

The document editing in-progress phase S920 is a processing phase performed if the user has updated a document attribute during document editing. In the document management system of the present embodiment, document attributes can also be updated while editing document data. Document attributes can be changed by the user changing or adding a check to the checkboxes 206 that function as the document category (attribute) selection field in FIG. 7.

In step S921, document attribute update processing is performed. In the document attribute update processing, the document attribute held in association with the document data in the document information storage unit 401 is updated based on the content of the user-designated change to the document attribute.

In step S923, document attribute re-allocation processing is performed. In the document attribute re-allocation processing, the document attribute held in the predetermined memory area of the main control unit 200 is re-set based on the content of the updated document attribute. Note that the subsequent steps are the same as the document ID filtering step S913, the memo ID filtering step S904, and the temporary comment repository updating step S905 in the document editing start phase S910.

The above processing completes the processing for updating the temporary comment repository 405 in the document editing in-progress phase.

In the present embodiment, the temporary comment repository 405 is maintained as long as the login session of the user continues. After the temporary comment repository update processing has ended, the temporary comment repository updating flow is ended. When the main control unit 200 detects that the user has updated the document attribute during editing of the document data, the document editing in-progress phase S920 is performed again, and the processing for updating the temporary comment repository 405 is performed again.

Knowledge Message List Updating

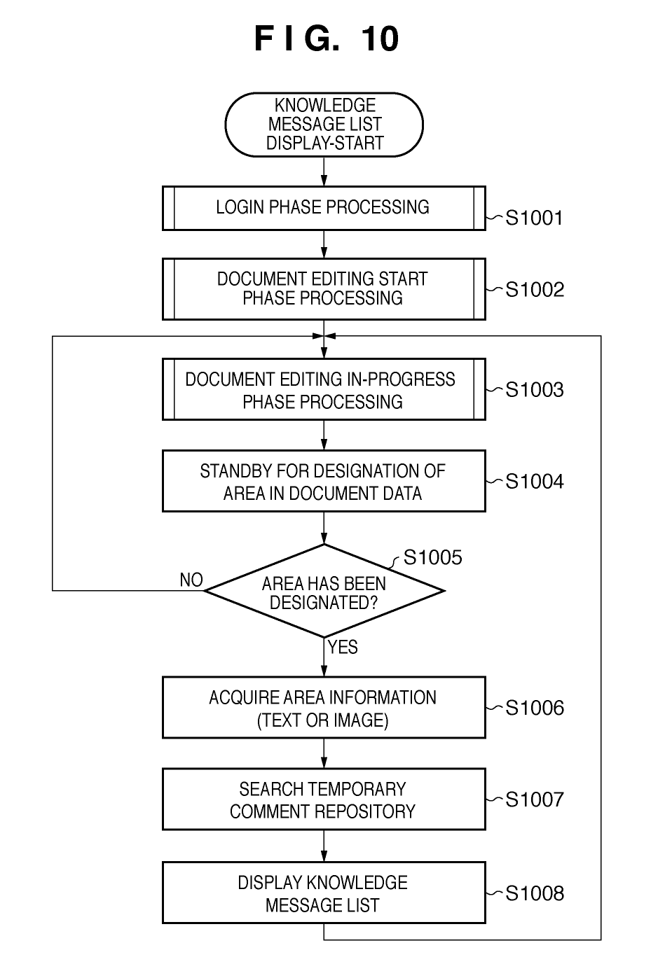

FIG. 10 is a flowchart illustrating a flow of processing for controlling display of a knowledge message list 205.

Knowledge message list display control is executed as part of the processing performed by the main control unit 200 described in FIG. 3, in accordance with an instruction from the main control unit 200.

First, in step S1001 login phase processing is performed. This login phase processing corresponds to the processing of the login phase S900 in FIG. 9. Next, in step S1002 document editing start phase processing is performed. This document editing start phase processing corresponds to the processing of the document editing start phase S910 in FIG. 9. In step S1003, document editing in-progress phase processing is performed. This document editing in-progress phase processing corresponds to the document editing in-progress phase S920 in FIG. 9.

Steps S1001, S1002, and S1003 are steps performed from when the user logs in to when moving to a state of editing the document data, and the temporary comment repository 405 is updated through these steps.

In step S1004, document data area designation standby processing is performed. This processing involves waiting in a selection/input standby state until a text area or image data area is selected by an arbitrary designation by the user while the document data is being edited. For example, this processing involves waiting in a reception standby state until the main control unit 200 has received a processing event such as a selection of text in the document data by a mouse click. The designated area in the document data is used as key information for searching the temporary comment repository 405 for knowledge messages.

In step S1005, judgment processing is performed. In the judgment processing, a judgment is made as to whether the user has designated a predetermined area of the document data. Note that if the predetermined area has not been designated, editing of the document data by the user is judged to be continued (step S1005:NO), and processing again moves to the document editing in-progress phase processing in step S1003. When the user selects the predetermined area of the document data being edited (step S1005:YES), processing proceeds to step S1006 in which the main control unit 200 acquires the text data or image data included in the area, as document data area information. If a text area has been selected, text data is acquired. If an image area has been selected, image data included in the selected area is acquired, and extraction processing is performed to extract an image feature amount from the acquired image data.

In step S1007, search processing is performed on the temporary comment repository 405 using the text data or image data acquired in the processing of step S1006 as the search key. This search processing is performed by the search processing unit 408 in accordance with an instruction from the main control unit 200. If the received search key is text data, the search processing unit 408 performs the search using text data in the temporary comment repository 405 as the search key. The search processing unit 408 searches for text data that matches the text data in the area designated while the document data is being browsed or edited. If the designated area is image data, feature amount data is used as the search key, and the search processing unit 408 performs similar image searching in order to search for image data having similar feature amount data based on the feature amount data stored in the temporary comment repository 405. In this case, if the partial area information designated in the document data editing operation is image data, the search processing unit 408 calculates a feature amount regarding the image data. The search processing unit 408 searches for document data having a similarity that is greater than or equal to a predetermined similarity, by performing a similarity operation using the calculated feature amount and the feature amounts stored in the temporary comment repository 405.

Note that the similar image search processing is performed by a comparison operation between the calculated feature amount and the feature amount data of image data that has been registered and stored in the temporary comment repository 405. The search result is managed by the main control unit 200, using the corresponding memo IDS as main keys. The main control unit 200 acquires the memo content and document IDs corresponding to the memo IDs from the comment management table 501, and transmits the acquired memo content and document IDs to the WebUI generation unit 203. The WebUI generation unit 203 generates HTML data so as to output (search result output) and display (search result display) the search result as rows that each contain a combination of a document ID and memo content that were received, and updates the knowledge message list screen (step S1008).

Note that after the knowledge message list updating step (step S1008), processing again returns to the document editing in-progress phase processing in step S1003, and the same processing is repeated.

The knowledge message list 205 shown in the example of FIG. 7 is the list whose display is controlled here.

Although the present describes an exemplary case in which the user designates an area by a mouse operation in the area information acquisition step S1006, the scope of the present invention is not limited to this example. For example, text data may be acquired by the user explicitly inputting a keyword into an input field provided in advance on a UI screen. In the case of image data, the user may explicitly designate an image data file on the UI screen.

Also, the document IDs displayed in the knowledge message list 205 are URL-linked to enable checking the document data to which the corresponding comments are assigned and the area designated by the user. Clicking a document ID displayed in the knowledge message list 205 enables the user to reference the actual document data to which the corresponding comment information was assigned. Referencing the document data enables the user to easily check to which areas in which document data the comment information displayed in the knowledge message list 205 was attached. Note that the URL links are generated by the WebUI generation unit 203, and each URL link is constituted from the corresponding document ID and location information indicating where the comment was assigned. The WebUI generation unit 203 can calculate the location information constituting the document URLs based on the text data or feature amount data stored in the comment management table 501, and coordinate data for specifying a location on a page in the document data. In this case, the coordinate data for specifying a location on a page constituting the document data can also be stored in the comment management table 501 when the area is designated.

### Other Embodiments

Needless to say, the object of the present invention can also be achieved by providing a system or apparatus with a computer-readable storage medium storing software programs that realize the functions of the above-described embodiment. Needless to say, the object of the present invention can furthermore be achieved by a computer (or CPU or MPU) in a system or apparatus reading and executing the programs stored on the storage medium.

In such cases, the actual programs read from the storage medium would realize the functions of the above-described embodiment, and the storage medium storing the programs would constitute the present invention.

Examples of storage media that can be used to supply the programs include a flexible disk, a hard disk, an optical disk, a magnetic disk, a CD-ROM, a CD-R, a non-volatile memory card, and a ROM.

Also, the functions of the above-described embodiment can be realized by the computer executing the read programs. Furthermore, needless to say, the present invention also includes a case in which the above-described embodiment is realized by part or all of the actual processing being performed based on instructions in the programs by an OS (Operating System) running on the computer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-028121, filed Feb. 7, 2008, which is hereby incorporated by reference herein in its entirety.

What is claimed is:

1. A document management system comprising:
a registration unit adapted to, for each of a plurality of document data pieces, register (i) information in a partial area constituting the document data piece and (ii) comment information added to describe content of the partial area information, in a storage unit in association with each other;
a search unit adapted to search the storage unit to find partial area information that corresponds to information in a partial area designated in a document data piece being browsed by a user; and
a search result display unit adapted to display, on a display unit, comment information added to the partial area information found by the search unit.

2. The document management system of claim 1,
wherein the registration unit further registers in the storage unit (iii) a document attribute for specifying, from among a plurality of document data pieces, the document data piece to which the comment information has been added and (iv) user information for specifying a user who added the comment information to the document data piece.

3. The document management system of claim 1, further comprising:
a reception unit adapted to receive user information for specifying a user who is browsing a document data piece;
a designation unit adapted to, during browsing of the document data piece, designate a document attribute for specifying the document data piece; and
a filter unit adapted to perform filtering on a plurality of document data pieces registered in the storage unit to obtain a document data piece associated with at least one of the user information received by the reception unit and the document attribute designated by the designation unit,
wherein the search unit performs the search on partial area information included in the document data piece obtained by the filter unit.

4. The document management system of claim 3, further comprising:
a calculation unit adapted to, if the partial area information is image data, calculate a feature amount of the image data,
wherein the registration unit registers the feature amount of the image data in the storage unit in association with the comment information, the document attribute, and the user information.

5. The document management system of claim 4,
wherein if the designated partial area information is image data, the search unit reads, from the storage unit, the comment information, the document attribute, and the feature amount associated with the document data piece obtained by the filter unit.

6. The document management system of claim 5,
wherein if the partial area information designated during browsing of the document data piece is image data, the calculation unit calculates a feature amount pertaining to the image data, and
the search unit performs the search to find the partial area information having a similarity that is greater than or equal to a predetermined similarity, by performing a similarity operation between the feature amount calculated by the calculation unit and the feature amount read from the storage unit.

7. The document management system of claim 1,
wherein if the partial area information designated during the browsing of the document data piece is text data, the search unit performs the search to find the partial area information that matches the text data.

8. The document management system of claim 2,
wherein the document attribute includes a document ID that is linked so as to enable accessing the document data piece, and
the search result display unit displays, on the display unit, a list display including a combination of the comment information and the document ID that is linked to enable accessing the document data piece including the partial area information that was found by the search unit.

9. The document management system of claim 8,
wherein the search result display unit displays, on the display unit, a combination of the list display and a document data browsing screen.

10. The document management system of claim 3,
wherein if content registered by the registration unit has been updated, the filter unit performs the filtering based on the updated registered content, and
the search unit reads, from the storage unit, the comment information, the document attribute, and the partial area information associated with the document data piece obtained by the filter unit, and updates the read comment information, document attribute, and partial area information.

11. A document management method in a document management system, the method comprising the steps of:
for each of a plurality of document data pieces, registering (i) information in a partial area constituting the document data piece and (ii) comment information added to describe content of the partial area information, in a storage unit in association with each other;
searching the storage unit to find partial area information that corresponds to information in a partial area designated in a document data piece being browsed by a user; and
displaying, on a display unit, comment information added to the partial area information found in the searching step.

12. The document management method of claim 11,
wherein in the registering step, (iii) a document attribute for specifying, from among a plurality of document data pieces, the document data piece to which the comment information has been added and (iv) user information for specifying a user who added the comment information to the document data piece are further registered in the storage unit.

13. The document management method of claim 11, further comprising the steps of:
receiving user information for specifying a user who is browsing a document data piece;
during browsing of the document data piece, designating a document attribute for specifying the document data piece; and
performing filtering on a plurality of document data pieces registered in the storage unit to obtain a document data piece associated with at least one of the user information received in the receiving step and the document attribute designated in the designating step,
wherein in the searching step, the search is performed on partial area information included in the document data piece obtained in the filtering step.

14. The document management method of claim 13, further comprising the step of:
if the partial area information is image data, calculating a feature amount of the image data,
wherein in the registering step, the feature amount of the image data is registered in the storage unit in association with the comment information, the document attribute, and the user information.

15. The document management method of claim 14,
wherein if the designated partial area information is image data, the comment information, the document attribute, and the feature amount associated with the document data piece obtained in the filtering step are read from the storage unit in the searching step.

16. The document management method of claim 15,
wherein if the partial area information designated during browsing of the document data piece is image data, a feature amount pertaining to the image data is calculated in the calculating step, and
in the searching step, the search is performed to find the partial area information having a similarity that is greater than or equal to a predetermined similarity, by performing a similarity operation between the feature amount calculated in the calculating step and the feature amount read from the storage unit.

17. The document management method of claim 11,
wherein if the partial area information designated during the browsing of the document data piece is text data, in the searching step the search is performed to find the partial area information that matches the text data.

18. The document management method of claim 12,
wherein the document attribute includes a document ID that is linked so as to enable accessing the document data piece, and
in the search result displaying step, a list display including a combination of the comment information and the document ID that is linked to enable accessing the document data piece including the partial area information that was found in the searching step is displayed on the display unit.

19. The document management method of claim 18,
wherein in the search result displaying step, a combination of the list display and a document data browsing screen is displayed on the display unit.

20. The document management method of claim 13,
wherein if content registered in the registering step has been updated, in the filtering step the filtering is performed based on the updated registered content, and
in the searching step, the comment information, the document attribute, and the partial area information associated with the document data piece obtained in the filtering step are read from the storage unit and updated.

21. A document management apparatus comprising:
a registration unit adapted to, for each of a plurality of document data pieces, register (i) information in a partial area constituting the document data piece and (ii) comment information added to describe content of the partial area information, in a storage unit in association with each other;
a search unit adapted to search the storage unit to find partial area information that corresponds to information in a partial area designated in a document data piece being browsed by a user; and
a search result output unit adapted to output comment information added to the partial area information found by the search unit.

22. The document management apparatus of claim 21,
wherein the registration unit further registers in the storage unit (iii) a document attribute for specifying, from among a plurality of document data pieces, the document data piece to which the comment information has been added and (iv) user information for specifying a user who added the comment information to the document data piece.

23. The document management apparatus of claim 21, further comprising:
a reception unit adapted to receive user information for specifying a user who is browsing a document data piece;
a designation unit adapted to, during browsing of the document data piece, designate a document attribute for specifying the document data piece; and
a filter unit adapted to perform filtering on a plurality of document data pieces registered in the storage unit to obtain a document data piece associated with at least one of the user information received by the reception unit and the document attribute designated by the designation unit,
wherein the search unit performs the search on partial area information included in the document data piece obtained by the filter unit.

24. A document management method in a document management apparatus, the method comprising the steps of:
for each of a plurality of document data pieces, registering (i) information in a partial area constituting the document data piece and (ii) comment information added to describe content of the partial area information, in a storage unit in association with each other;
searching the storage unit to find partial area information that corresponds to information in a partial area designated in a document data piece being browsed by a user; and
outputting comment information added to the partial area information found in the searching step.

25. The document management method of claim 24,
wherein in the registering step, (iii) a document attribute for specifying, from among a plurality of document data pieces, the document data piece to which the comment information has been added and (iv) user information for specifying a user who added the comment information to the document data piece are further registered in the storage unit.

26. The document management method of claim 24, further comprising the steps of:
receiving user information for specifying a user who is browsing a document data piece;
during browsing of the document data piece, designating a document attribute for specifying the document data piece; and
performing filtering on a plurality of document data pieces registered in the storage unit to obtain a document data piece associated with at least one of the user information received in the receiving step and the document attribute designated in the designating step,
wherein in the searching step, the search is performed on partial area information included in the document data piece obtained in the filtering step.

27. A program that is stored on a computer-readable storage medium and causes a computer to execute a document management method in a document management apparatus, the method comprising the steps of:
for each of a plurality of document data pieces, registering (i) information in a partial area constituting the document data piece and (ii) comment information added to describe content of the partial area information, in a storage unit in association with each other;
searching the storage unit to find partial area information that corresponds to information in a partial area designated in a document data piece being browsed by a user; and
outputting comment information added to the partial area information found in the searching step.
